(19) United States
(12) Patent Application Publication
(10) Pub. No.: US 2008/0274342 A1
(43) Pub. Date: Nov. 6, 2008

(54) Edging And Mats Made Of Recycled Material And Related Manufacturing Methods

(75) Inventor: Richard C. Moore, Charleston, SC (US)

Correspondence Address: TURNER PADGET GRAHAM & LANEY, P.A., P.O. BOX 1509, GREENVILLE, SC, 29602, US

(73) Assignee: Easy Gardener, Inc.

(21) Appl. No.: 11/776,294

(22) Filed: Jul. 11, 2007

Related U.S. Application Data
(63) Continuation-in-part of application No. 11/742,809, filed on May 1, 2007.
Application No. 11/742,809 is a continuation-in-part of application No. 11/742,853, filed on May 1, 2007, now abandoned.

(51) Int. Cl. B32B 25/12; B28B 1/14

(52) U.S. Cl. 428/220; 264/308; 428/492

(57) ABSTRACT

Methods of manufacturing multi-colored, rubber pads such as edging and mats include providing a mold; mixing together a rubber component, a binder and a first coloring agent to form a matrix having a first colored surface; and introducing a second coloring agent onto the matrix to create a multicolored pad having a second colored surface opposite the first colored surface.

The present application is a continuation-in-part application of and claims priority to co-pending U.S. patent application Ser. No. 11/742,809, filed May 1, 2007, entitled “Stepping Stones Made of Recycled Material and Related Manufacturing Methods” and U.S. patent application Ser. No. 11/742,853, filed May 1, 2007 entitled “Edging and Mats Made of Recycled Material and Related Manufacturing Methods”.

### BACKGROUND OF THE DISCLOSURE

In order to beautify lawns, gardens and other outdoor grounds, edging components or mulch and the like are used to define edges and borders around lawns, trees, and other plant life. Conventional edging materials are intended to present a manicured appearance and to prevent grass and weeds from growing in undesired areas.

Edging components may be colored green, brown, or black, yet still present an unnatural appearance when manufactured from metal or plastic. Wooden edging components, even if chemically treated, become aesthetically unpleasing as they fade and deteriorate due to weather exposure.

Mulch also suffers from many drawbacks. Typically, mulch washes or blows away or decomposes over time and must be replenished at least seasonally. Therefore, mulch is not cost effective over time, especially when accounting for repeated labor to replace the mulch each season. Moreover, mulch tends to stick to shoe soles to be tracked into homes and buildings, especially if the mulch is wet due to rain or watering.

A shared drawback of conventional edging and mulch is color limitation. Conventional edging and mulch can not simply be inverted or reversed to reveal a different color if a homeowner desires to change a landscape.

A multi-colored edging system is needed in the lawn and garden care industry to offer consumers a greater choice at a reasonable cost.

### BRIEF SUMMARY OF THE DISCLOSURE

The present disclosure is directed in general to multi-colored edging or edging systems and mats made from recycled rubber. The edging systems are used to create natural but manicured edges along walkways and around trees, shrubbery, flower beds, posts, poles and the like to define lawn boundaries and to inhibit grass and weed growth along these edges. The mats, which are produced similar to the edging systems, are used to create larger manicured edges or areas for situating water hose storage carts, outdoor garden supply sheds, playground equipment and the like in order to render mowing or trimming around or under such items unnecessary.

The multi-colored edging systems and mats—collectively, referred to herein as pads—are made, for example, by recycling a waste product such as used rubber tires. The multi-colored edging systems and mats may have a variety of color combinations; for instance, brown on one of their sides and red on the opposite side. Accordingly, a home improvement store, garden store or the like need only use one section of limited floor or shelf space and still be able to offer a choice of at least two colored products to consumers. Thus, while one consumer may want a brown mat and another consumer may want a red mat, both consumers can each purchase one of the brown-red mats and simply place the desired color facing up to create their respective mulch-like areas. Moreover, where the store previously had offered only a choice of brown and red mats—each occupying a section of floor or shelf space—the store can now offer another color combination such as mats having green on one side and black on the other, thus doubling consumer choices in this example to four colors using the same two sections of floor or shelf space.

Evident from the foregoing introduction, the component parts and ingredients of the multi-colored edging systems and mats are simple and economical to manufacture and use. Other advantages of the invention will be apparent from the following description and the attached drawings or can be learned through practice of the invention.

According to an exemplary process of the present disclosure, a mold is manufactured to half the desired thickness of the finished product. Rubber is mixed with binder and pigment. The resultant mixture is weighed and placed into the mold then smoothed and leveled in the mold. The compacted mixture is conveyed to a second mixing station, and a square, rectangular or other shaped frame with an inside area equal to the outside area is placed over the first mold. The frame may have a ledge protruding inward to facilitate seating the frame onto the mold. A second color is poured into the mold, compacted and cured. After curing, the frame is removed and the finished product extracted from the mold. Finished edging systems or mats are packaged for shipping and sale.

In producing functionally useful edging systems or mats, it is also desirable that the edging systems and mats have a natural aesthetic appearance; i.e., an indigenous mulch-like appearance. However, rubber tire particles are typically coal black, while the binder coating them typically is clear, or may be yellowish in appearance. Frequently, such binder/granule mix, when cured, may have an undesirable color and/or sheen or gloss. Accordingly, the disclosure provides edging systems and mats from ground-up, waste rubber and a binder, and means for controlling the appearance of the cured edging systems and mats to provide desirable color and aesthetics.

Specifically, to produce edging systems or mats according to an aspect of the disclosure, a binder (e.g., urethane) is utilized and is mixed together with pigment to provide a desirable color. This binder-pigment mixture is mixed with a catalyst to promote curing and with the ground rubber and fibers. This mixture is then molded into a desired shape and a diatomaceous earth or silica is sprinkled over the uncured mixture to produce a desirable anti-gloss effect in the cured edging systems or mats so produced.

According to another aspect of the disclosure, a rubber pad includes a first rubber surface being configured for contacting ground, the first rubber surface having a first color and a plurality of rubber components configured to appear as mulch, the first color being cured with the rubber components; a second surface opposite the first surface, the second surface being configured for alternative contact with the ground, the second surface having a second color different from the first color and a plurality of the rubber components configured to appear as mulch, the second color being cured with the rubber components; and a binder holding the respective first and second rubber components together. In this aspect, the pad may be a rubber mat or a rubber edging system.

The first and second colors in this aspect may be red, white, brown, green, blue, sandstone or black, the first color being different from the second color. The first and second colors are derived from respective coloring pigments.

Also in this aspect, the rubber pad may have a thickness of about 0.5 inches to about 1 inch.

Further in this aspect, the first and second rubber components may be rubber buffings, rubber granules or combinations thereof. The rubber buffings and rubber granules may be derived from used rubber tires, or other used or natural rubber sources or other elastomeric materials.

Also in this aspect, the binder may include a moisture curable urethane. A curing catalyst and/or an anti-gloss agent may also be added.

The rubber pad may also include an interlock configured to mate the rubber pad with a complementary rubber pad.

In another aspect of the disclosure, a method of manufacturing a multi-colored rubber pad may include providing a mold; mixing together a rubber component, a binder and a first coloring agent to form a matrix having a first colored surface; and introducing a second coloring agent onto the matrix to create a multicolored rubber pad having a second colored surface opposite the first colored surface.

The mold in this aspect may have a height of about one-half inch to about two inches, the height being about half a desired thickness of the rubber pad. The mold may also have an area of about twelve square inches to about forty square inches.

Further in this aspect, the rubber component may be leveled with the binder and the first coloring agent. Also, the rubber component, the binder and the first coloring agent may be cured such as by removal of moisture; e.g., air drying. However, the curing may be accomplished by a chemical reaction. The curing may also be accomplished by heat, compression, adhesive, and combinations thereof.

Still further in this aspect, a plurality of fibers may be mixed with the rubber component, the binder and the first coloring agent. A catalyst may also be mixed with the rubber component, the binder and the first coloring agent. The second coloring agent may be leveled and cured.

Also in this aspect, the mold may be joined with a cap. The mold may include a peripheral lip and a projection, the projection depending from the peripheral lip. The cap may include a ledge defining a shoulder, the projection and the ledge complementarily shaped to seat the cap and the mold together. Still further, one or both of the first and second colored surfaces may be embossed such as with an embossing roll such that each surface has a different texture.

Accordingly, edging systems or mats of the composition according to the present disclosure can be used over ground to delineate lawn edges or outdoor equipment storage areas. Moreover, due to their multiple colors, the products save storage and sales space; i.e., one multicolored edging systems or mats is attractive to different consumers having different landscaping needs.

### BRIEF DESCRIPTION OF THE DRAWINGS

The above and other aspects and advantages of the present invention are apparent from the detailed description below in combination with the drawings, in which:

FIG. 1 is a perspective view of an embodiment of an edging system shown in an intended use according to an aspect of the disclosure;

FIG. 2A is a perspective view of the edging system as in FIG. 1, particularly showing opposing sides having different colors;

FIG. 2B is a plan view of the edging system as in FIG. 2A, particularly showing a mulch-like surface as the edging system is being unrolled in accordance with an aspect of the disclosure;

FIG. 3A is a perspective view another embodiment according to an aspect of the disclosure, particularly showing a mat having opposing sides with different colors;

FIG. 3B is a plan view of the mat as in FIG. 3A, particularly showing a mulch-like surface of one side in accordance with an aspect of the disclosure;

FIG. 3C is an elevational view of the mat as in FIGS. 3A and 3B, shown in an intended use according to an aspect of the disclosure;

FIG. 4 is a plan view of another embodiment similar to FIGS. 3A-3C according to a further aspect of the disclosure;

FIG. 5 is a schematic view of a manufacturing line showing a process of forming edging systems or mats as in FIGS. 1-4 with different colored opposing surfaces according to another aspect of the disclosure;

FIG. 6 are schematic plan and elevational views of components of the manufacturing line as in FIG. 5 according to another aspect of the disclosure; and

FIG. 7 is a schematic view of alternative portions of a manufacturing line as in FIG. 4 according to another aspect of the disclosure.

### DETAILED DESCRIPTION OF THE DISCLOSURE

Detailed reference will now be made to the drawings in which examples embodying the present disclosure are shown. The detailed description uses numerical and letter designations to refer to features of the drawings. Like or similar designations of the drawings and description have been used to refer to like or similar parts of various embodiments according the disclosure.

The drawings and detailed description provide a full and detailed written description of the disclosure and of the manner and process of making and using various embodiments, so as to enable one skilled in the pertinent art to make and use them, as well as the best mode of carrying out the disclosure. However, the examples set forth in the drawings and detailed description are provided by way of explanation of the disclosure and are not meant as limitations of the disclosure. The present disclosure thus includes any modifications and variations of the following examples as come within the scope of the appended claims and their equivalents.

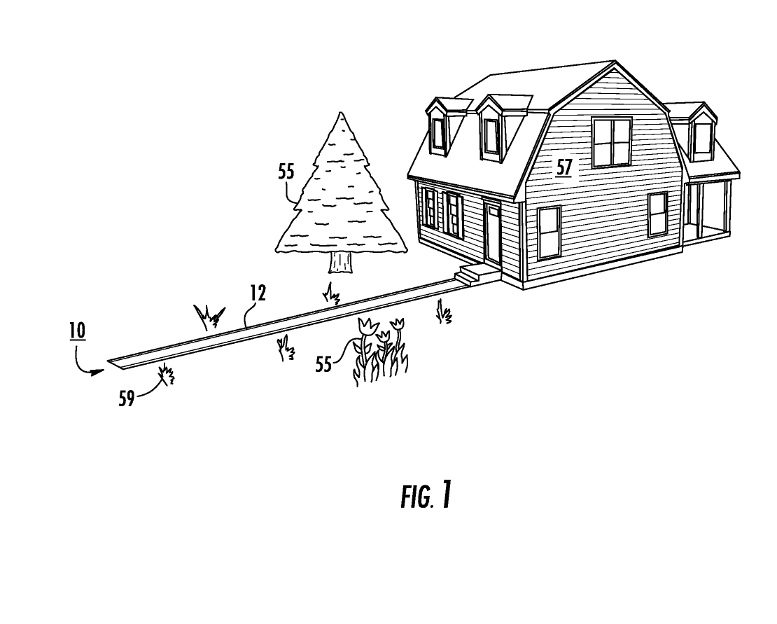

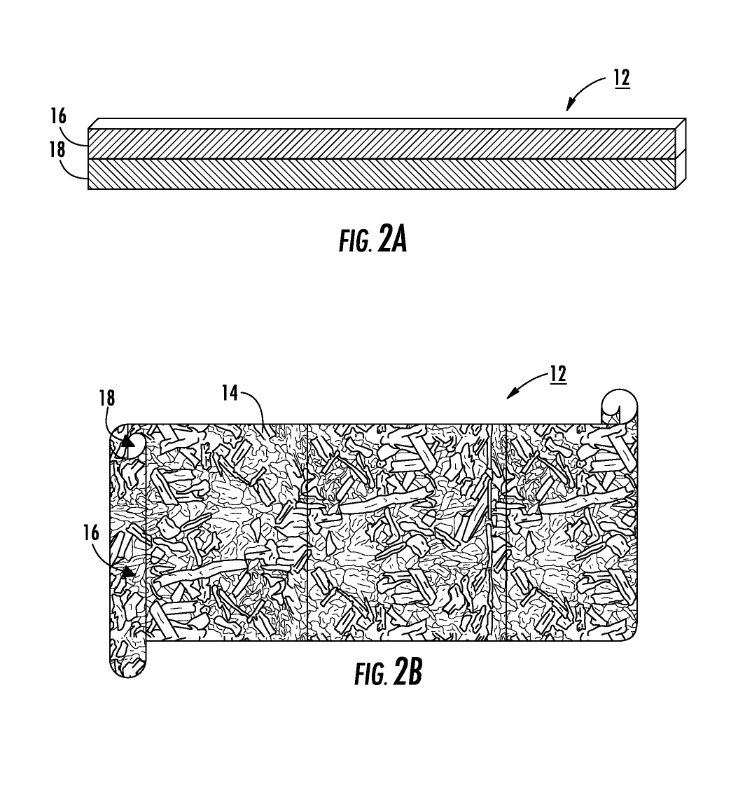

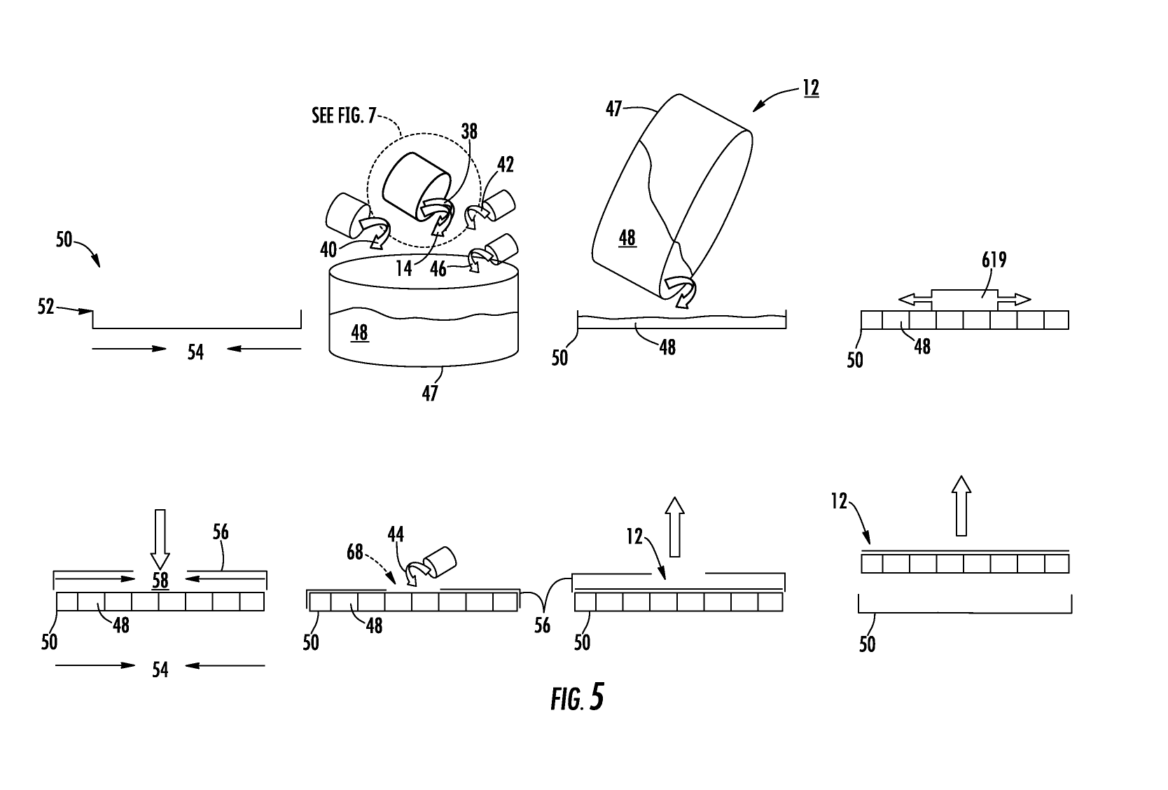

Turning now to the figures, according to one aspect of the disclosure edges of a path or walkway 10 may be defined and manicured using an edging system, which is designated in general by the element number 12. As broadly embodied in FIGS. 1-2B, the edging system 12 may be manufactured by chipping, buffing, cutting or chopping used tires, or other recyclable rubber, into rubber pieces 14 made to look like mulch, pebbles or other natural materials. According to exemplary manufacturing processes as described in detail below with respect to FIGS. 5-7, the rubber pieces 14 are combined with a curable binder to form a matrix that is shaped, colored and cured into the edging system 12.

With particular reference to FIG. 1, the edging system 12 is shown lining a path 10 between trees, flower beds, posts, poles and the like, represented in general by the element number 55. In this example, the path 10 leads to a house 57, and the edging system 12 prevents grass or weeds, generally 59, from encroaching near or onto the path 10. Since the edging system 12 is durable and resilient as described in detail below, mowing or trimming the grass 59 adjacent to the edging system 12 generally will not harm the edging system 12.

Although the edging system 12 in FIG. 1 is shown in a substantially straight line, the skilled artisan will appreciate that the edging system 12 can be manufactured in a variety of shapes, or tailored, as desired. For instance, those skilled in the art will appreciate that the edging system 12 may be formed or cut with curves to complement curved paths and irregularly shaped flower beds 55, Thus, the edging system 12 is not limited to the exemplary shapes and uses depicted in the figures.

FIGS. 2A and 2B most clearly show that the edging system 12 includes an upper or first colored surface 16 and an opposing second or lower colored surface 18. In this example, the first surface 16 appears as a mulch-like surface and the opposing surface 18 appears as a pebbled surface. In some cases, both the first surface 16 and the second surface 18 can be made to have the same textured appearance, for instance mulch-like surfaces but with different colors. In any case, as introduced, either of the surfaces 16, 18 can engage the ground. The choice is simply dependent upon which colored surface and/or which textured appearance the property owner desires to display. The property owner may even wish to display one color or texture one season then turn the edging system 12 over during the following season to display the other side.

The exemplary edging system 12 shown in FIGS. 2A and 2B is about five and one-half inches in width by eight feet in length by one-half inch in thickness (5½ in.×8 ft.×½ in.). However, the edging system 12 may be manufactured in a variety of sizes including but not limited to 4½ in.×10 ft.×½ in. and 5½ in.×10 ft.×1 in. These parameters may be varied as required as described in detail below with respect to FIGS. 5-7.

Also as briefly introduced above, mowing or trimming around the edging system 12 of FIGS. 2A and 2B generally will not harm the edging system 12 for at least two reasons. First, the edging system 12 is made of resilient rubber which will simply deflect, for instance, a trimming line (not shown). Second, the edging system 12 may be depressed into the ground so only one of the colored surfaces 16, 18 is exposed. Accordingly, the exposed surface typically will be relatively ground level or at a desired height such that blades of a lawnmower, for instance, will pass over the edging system 12 without striking the edging system 12.

With more particular reference to the example shown in FIG. 2A, the first colored surface 16 is brown in color and the second colored surface 18 is red in color. However, an almost limitless variety of colors and color combinations are within the scope of the present disclosure, and the edging system 12 is not limited to the exemplary brown-red combination. For instance, brown-green, brown-black, red-green, red-black and numerous other color combinations and shades of colors can be provided. Also, although natural colors and color combinations that mimic stones, wood, grass and the like are expected in most cases, it is conceivable that some property owners may want peculiar colors (e.g., pink, purple) to compliment a particular motif or to decorate for a special occasion; thus, the possible colors and color combinations for the edging system 12 are only limited by consumer imagination. Further details regarding processes for coloring the surfaces 16, 18 are described below with respect to FIGS. 5-7.

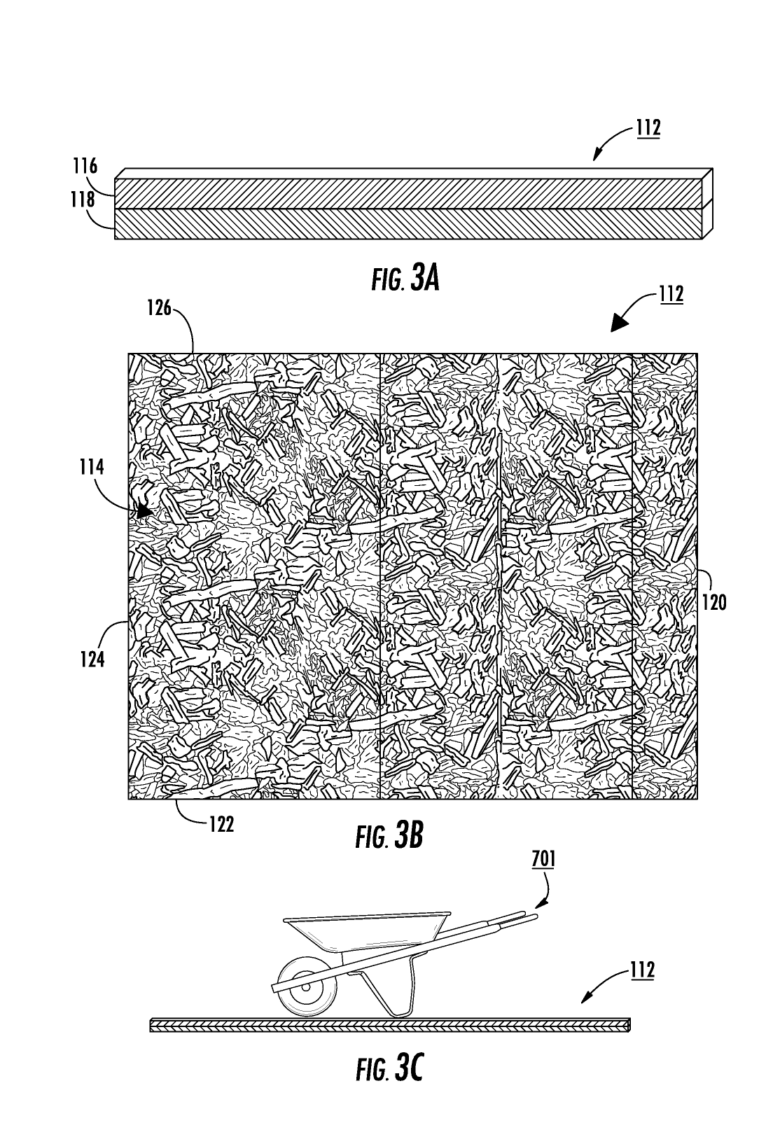

Turning now to FIGS. 3A, 3B and 3C, a lawn and garden mat 112 is shown, which is made similarly to the edging system 12 discussed above. In the example shown in FIGS. 3A, 3B and 3C, the mat 112 is about eighteen square inches (18 in.²) but can be made larger or smaller depending on customer requirements and specifications; for instance, the mat 112 may be anywhere from 18 in. to about 36 in. wide and 24 in. to 48 in. long. Like the edging system 12, the mat 112 may be made of elongated “buffing” feedstock 114 to present a mulch-like appearance as shown. However, the mat 112 may also be made from granular rubber pieces, at least on one of the sides 116, 118 to provide customers with a choice in textures and appearance.

FIG. 3C most clearly shows that the mat 112 may be used to park or store lawn and garden equipment 701. Accordingly, mowing or trimming grass and weeds around the equipment 701 is unnecessary. Moreover, by virtue of substantially straight edges or sides 114, 116, 118 and 120 on each of the exemplary mats 112, a plurality of the mats 112 may be abutted against each other to form a relatively large, patio-type area in which there are no large gaps between the mats 112. Such a large assembly of the mats 112 may be useful under outdoor decks and the like where it is desirable to inhibit growth of weeds and grass but where mulch is difficult to maintain.

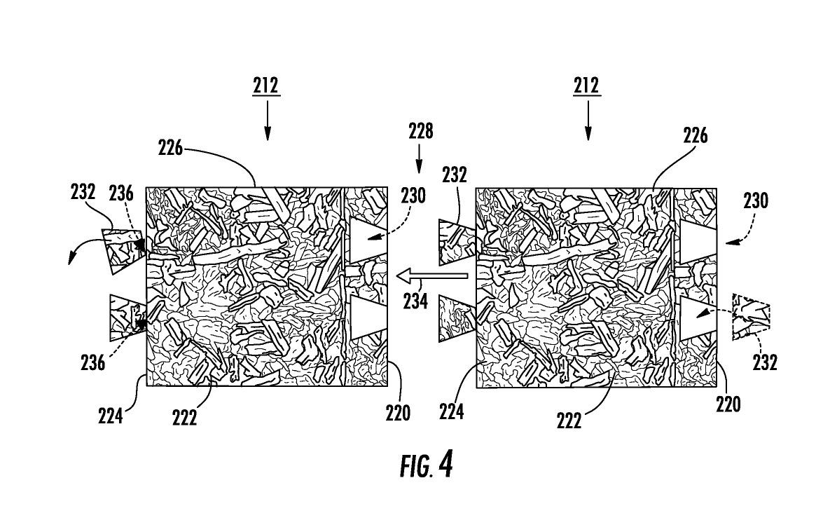

With reference now to FIG. 4, a plurality of mats 212 having dual colors and/or textures and other components similar to the previous embodiments may be provided with an interlocking key system or interlock 228. As shown in this example, respective sides 220 of the mats 212 may include one or more indentations or keyholes 230. One or more complementary projections or keys 232 of a side 224 of another mat 212 slide, snap or press-fit into the respective keyholes 230 as indicated by arrow 234. Accordingly, two mats 212 may be joined together to form a relatively seamless section but may be easily separated later to repair or replace the mats 212, or to reposition the combined mats, or to invert the mats 212 to reveal their alternative color and/or textures as discussed above.

The skilled artisan will instantly appreciate that although the sides 220, 222, 224, 226 of the mats 212 in FIG. 4 are relatively straight (notwithstanding the keyholes 230 and keys 232) any or all of the sides may be shaped irregularly to mimic natural stones and stone pavers or to curve around gardens, ponds and the like. Moreover, those skilled in the art will appreciate that fewer or additional keyholes 230 and keys 232 may be formed in the mats 212 and may be used on any or all of the sides 220, 222, 224, 226 to form a relatively larger patio-type surface if desired.

FIG. 4 further shows that after the desired number of mats 212 are laid down and connected together, the keys 232 of the last mat 212 may be snapped or torn off at respective lines of weakness 236. The separated keys 232 may then be used to fill in the keyholes 230 on another mat 212 at an opposing end of the patio or area as indicated by the phantom key 232 in order to smooth or otherwise fill-in the opposing end.

Turning now to FIGS. 5, 6 and 7, as briefly introduced above, the edging system 12 (as well as the mats 112, 212) may be made of rubber 14, and possibly fibers 38, from used tires 610 or other rubber sources. As described in greater detail below, the rubber 14, the fibers 38, a curable binder 40 (described below), one or more colors (alternatively referred to herein as coloring agents or pigments) 42, 44 and/or a catalyst 46 are mixed together to form a matrix or mixture 48 used to generate the edging system 12 or the mats 112, 212. For simplicity, the following exemplary methods will refer primarily to the edging system 12 but will be understood to refer to and include processes for manufacturing the mats 112, 212 unless expressly stated otherwise.

With particular reference to FIG. 5, the edging system 12 is produced in this example having a thickness ranging from about one-half inch (0.5″) to about one inch (1″), although other thickness can be produced as noted above. More specifically, a ring or mold 50 is produced as shown in FIG. 5 that is half the desired thickness of the edging system 12 as dictated by a top level 52 of the mold 50. Also shown, the mold 50 has a length and a width that ultimately dictate a corresponding footprint or area 54 of the mats 112, 212.

FIG. 5 further shows that the rubber 14 is mixed in at a first mixing station 47, with or without the fibers 38, and with the curable binder 40, the coloring agent 42 and/or the catalyst 46 to form the mixture 48. The mixture 48 is weighed and placed into the mold 50 then smoothed with a smoothing device 619, or manually leveled, substantially even with the top level 52 of the mold 50. As shown, the compacted mixture 48 is conveyed to a second station where a section or cap 56 having an inside area 58 equal to the area 54 is placed over the mold 50.

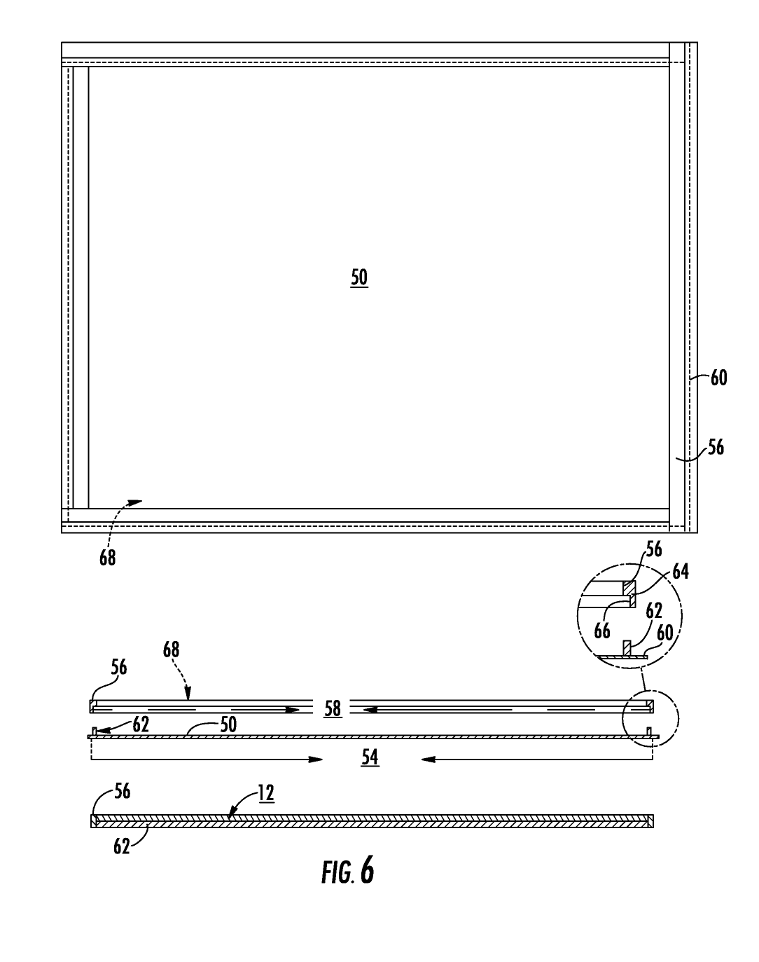

FIG. 6 most clearly shows that the mold 50 may have a peripheral lip 60 from which a projection or anchor 62 projects. The cap 56 may have a complementary or compatible ledge or projection 64 protruding outward to define a shoulder 66. As shown, the anchor 62 and the ledge 64 seat together to seat the cap 56 onto the mold 50. Those skilled in the art of molds will instantly appreciate that the anchor 62 and the ledge 64 may be reversed or arranged in a variety of other orientations relative to each other and are not limited to the example shown in FIG. 6.

With reference to both FIGS. 5 and 6, the second color 44 is poured into the mold 50 through, for instance, a hole or opening 68 in the cap 56 and onto the mixture 48, which has assumed the color of the first color 42. As particularly shown in FIG. 6, the opening 68 is substantially equal in area to an inside area of the mold 50 to easily spread and compact the second color 44 onto the mixture 48. However, the opening 68 can be smaller such as shown schematically in FIG. 5. If the opening 68 is relatively smaller, other means such as vibration can be employed to spread the second color 44 onto the mixture 48.

As further shown in FIG. 5, the second color 44 and the mixture 48 are cured. Afterwards, the cap 56 is removed and the finished product—the edging system 12 in this example—is extracted from the mold 50. Finished edging systems 12 are then packaged, such as in shrink wrap, for shipment to stores.

Alternative means of providing different colored surfaces 16, 18 include painting one or both of the surfaces 16, 18 after the mixture 48 has cured. However, paint has been found to dry around individual fibers of the edging system 12, leaving black-appearing open spaces and thus, a less natural appearance. Paint also has a tendency to chip or peel away after prolonged exposure to weather and wear.

Another alternative coloring means is to form two separate edging system components, each having different colors. After curing, the two components may be glued or heat-pressed together using, for instance, a urethane bond. However, this multi-coloring alternative is more expensive than other methods described herein and may result in a lower grade product that is more susceptible to separation.

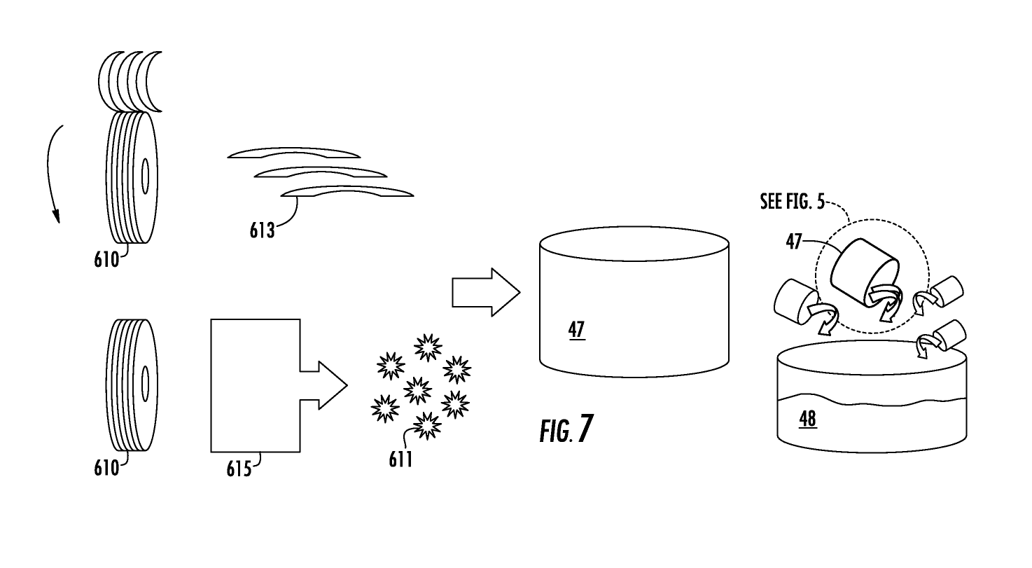

With reference now to FIG. 7, the rubber 14 in the mixture 48 can be obtained from used tires 610 in the form of granules 611 or buffings 613. As shown, the granules 611 are generally in the range of about ⅛ inch to about ¾ inch in major dimension. For instance, when the used tires 610 (or retread pieces) are ground in a granulator 615, steel components are removed, leaving the rubber granules 611. If buffings 613 are desired in the final product, a buffing machine 617 is rotated about the tire 610 (or vice versa) shedding generally finger-like buffings 613 (e.g., about 0.5 inches to about 3 inches in length and about 0.25 to about 1 inch in width). Either or both the granules 611 and the buffings 613 can be used in the mixture 48, although it has been discovered that the buffings 611 provide the edging system 12 a relatively more natural mulch-like appearance. If desired, the mixture 48 can be embossed as shown in FIG. 5 to further modify the appearance of the edging system 12. For instance, the cap 56 may contain projections or patterning devices facing the mixture 48 to impart a desired pattern on the mixture 48.

If rayon, nylon or other such materials were used in the tires 610, the discrete fibers 38 of such materials, about one inch or less in length, may also be a byproduct of shredding, mulching, granulating or buffering the tires 610. More specifically, the general range of ratios of all edging system or mat materials by weight is from about 9 or 10 to about 4 or 5 to 1 with the preferable ratio being about 8 to 1. The voids to solids volumetric weight ratio is about 1 to 10.

With reference to both FIGS. 5 and 7, as introduced above, the foregoing materials are mixed with the appropriate, curable binder 40 such as latex or a urethane binder. One suitable binder for use as the curable binder 40 is moisture curable, polyurethane, #2040, manufactured by the ICI Polyurethane division of ICI Americas Inc.

As noted above, the finished product 12 should be as natural in appearance as possible. Accordingly, color and sheen are controlled. The coloring agents 42, 44, briefly introduced above, may be an iron oxide pigment, No. 4701, manufactured by PDI of ICI Americas, Inc., or any other suitable pigment. To control sheen or gloss for a more natural-like appearance, the coloring agents 42, 44 may include an anti-gloss agent, or a separate agent such as diatomaceous silica, such as celite #499 manufactured by Manville Filtration and Minerals, may be used. The diatomaceous silica is, for instance, sprinkled on the surface of the uncured, molded mixture 48 to provide an anti-gloss effect. The skilled artisan will appreciate that any suitable pigment and anti-gloss additives may be used.

Finally, as shown in FIGS. 5 and 7, the catalyst 46, briefly introduced above, is used as needed. An exemplary catalyst for use as the catalyst 46 is Dabco No. T-12 manufactured by Air Products and Chemicals Company.

By way of example, the final mixture 48 by weight may be about 12 to 14% rubber granules 611; 75% to 77% 12 to 14% rubber buffings 613; about 0 to 2% fiber 38; about 11% binder 40; about 2 to 5% coloring agent 42, 44 by weight of total binder; about 0.01 to 0.03% catalyst 46 by weight of total binder; and about negligible percent U.V. light stabilizers and anti-oxidants. Such a mixture 48, when cured, weighs about 1.25 grams per cubic centimeter, and has a solids-to-voids volumetric ratio of about 5 to 1. Of course, this ratio can be adjusted by varying the sizes of the rubber granules 611 and/or the rubber buffings 613. For example, an increase in particle size will generally provide more air volume while a decrease in particle size will generally provide less air volume.

While preferred embodiments of the invention have been shown and described, those skilled in the art will recognize that other changes and modifications may be made to the foregoing examples without departing from the scope and spirit of the invention. For instance, dimensions such as areas of the products can be changed to accommodate various walkway requirements. Likewise, different rubber or other durable elastomeric materials can be used to manufacture the products described herein. It is intended to claim all such changes and modifications as fall within the scope of the appended claims and their equivalents. Moreover, references herein to “top,” “bottom,” “upward,” “upper,” “higher,” “lower,” “downward,” “descending,” “ascending,” “side,” “first,” and “second” structures, elements, designations, geometries and the like are intended solely for purposes of providing an enabling disclosure and in no way suggest limitations regarding the operative orientation or order of the exemplary embodiments or any components thereof.

That which is claimed is:

1. A rubber pad, comprising:
a first rubber surface being configured for contacting ground, the first rubber surface having a first color and a plurality of rubber components configured to appear as mulch, the first color being cured with the rubber components;
a second surface opposite the first surface, the second surface being configured for alternative contact with the ground, the second surface having a second color different from the first color and a plurality of the rubber components configured to appear as mulch, the second color being cured with the rubber components; and
a binder holding the respective first and second rubber components together.

2. The rubber pad as in claim 1, wherein the rubber pad is a rubber mat or a rubber edging system.

3. The rubber pad as in claim 1, wherein the first and second colors are selected from the group consisting of red, white, brown, green, blue, sandstone or black, the first color being different from the second color.

4. The rubber pad as in claim 1, wherein the first and second colors are derived from respective coloring pigments.

5. The rubber pad as in claim 1, wherein the rubber pad has a thickness of about 0.5 inches to about 1 inch.

6. The rubber pad as in claim 1, wherein the first and second rubber components are selected from the group consisting of rubber buffings and rubber granules.

7. The rubber pad as in claim 6, wherein the rubber buffings and rubber granules are derived from used rubber tires.

8. The rubber pad as in claim 1, wherein the binder includes moisture curable urethane.

9. The rubber pad as in claim 1, further comprising a curing catalyst and an anti-gloss agent.

10. The rubber pad as in claim 1, further comprising an interlock being configured to mate the rubber pad with a complementary rubber pad.

11. A method of manufacturing a multi-colored rubber pad, comprising:
providing a mold;
mixing together a rubber component, a binder and a first coloring agent to form a matrix having a first colored surface; and
introducing a second coloring agent onto the matrix to create a multicolored rubber pad having a second colored surface opposite the first colored surface.

12. The method as in claim 11, wherein the mold defines a height of about one-half inch to about two inches, the height being about half a desired thickness of the rubber pad.

13. The method as in claim 11, wherein the mold defines an area of about twelve square inches to about forty square inches.

14. The method as in claim 11, further comprising leveling the rubber component, the binder and the first coloring agent.

15. The method as in claim 11, further comprising curing the rubber component, the binder and the first coloring agent.

16. The method as in claim 15, wherein the curing is accomplished by a chemical reaction.

17. The method as in claim 15, wherein the curing is accomplished by heat, compression, adhesive, and combinations thereof.

18. The method as in claim 11, further comprising mixing a plurality of fibers with the rubber component, the binder and the first coloring agent.

19. The method as in claim 11, further comprising mixing a catalyst with the rubber component, the binder and the first coloring agent.

20. The method as in claim 11, further comprising leveling the second coloring agent.

21. The method as in claim 11, further comprising curing the second coloring agent.

22. The method as in claim 11, further comprising joining the mold with a cap.

23. The method as in claim 22, wherein the mold includes a peripheral lip and a projection, the projection depending from the peripheral lip.

24. The method as in claim 22, wherein the cap includes a ledge defining a shoulder, the projection and the ledge complementarily shaped to seat the cap and the mold together.

25. The method as in claim 11, further comprising embossing one of the first and second colored surfaces such that each surface has a different texture.
